(19) United States
(12) Patent Application Publication
(10) Pub. No.: US 2008/0278604 A1
(43) Pub. Date: Nov. 13, 2008

(54) Apparatus, System and Method for Processing and Transferring Captured Video Data

(75) Inventors: David Watkins, London (GB); Anita Briginshaw, Cambs (GB); Evangelos Pappas-Katsiafas, Caldecote Cambs (GB); Xing Yu, London (GB); Michael Rowbothom, Surrey (GB); Ben Henricksen, Cambs (GB); Paul Jones, London (GB)

Correspondence Address: CONLEY ROSE, P.C.;David A. Rose, P. O. BOX 3267, HOUSTON, TX, 77253-3267, US

(73) Assignee: OVERVIEW LIMITED, London (GB)

(21) Appl. No.: 11/915,649

(22) PCT Filed: Apr. 18, 2006
(86) PCT No.: PCT/GB2006/001394

§ 371 Date: Jul. 17, 2008

(30) Foreign Application Priority Data
May 27, 2005 (GB) 0510890.7
Sep. 27, 2005 (GB) 0519655.5
Apr. 18, 2006 (GB) PCT/GB2006/001394

(51) Int. Cl. H04N 5/76

(52) U.S. Cl. 348/231.2

(57) ABSTRACT

A method of transferring video data comprises obtaining a stream of video frames from an video capture device and identifying at least one characteristic in at least one frame of the stream of video frames. Lookup data is generated which associates the at least one characteristic with its at least one identified video frame. At least one video frame in the stream of video frames having a given characteristic is determined and notification or at least one of the determined video frames is transmitted to a client. A video transfer system, video processing device and method of image identification are also described.

### CROSS-REFERENCE TO RELATED APPLICATION

The present application is a National Phase entry of PCT Application No. PCT/GB2006/001394 filed 18 Apr. 2006, which claims priority to GB Application No. 0510890.7 filed 27 May 2005 and GB Application No. 0519655.5 filed 27 Sep. 2005, all of which are hereby incorporated herein by reference.

### FIELD OF THE INVENTION

The present invention relates to a method of transferring video data, a video processing device and a method of image identification. Video data is received from a video capture device and selected frames of the video data are transferred to a client. Alternatively, a notification of the presence of selected frames in the captured video data is transmitted to a client. The client may be a mobile telephone.

### BACKGROUND OF THE INVENTION

The availability of inexpensive video capture devices in conjunction with an increase in the use of personal computers has resulted in a number of domestic surveillance systems which can be readily implemented by the domestic user. However, video recognition technology remains complex and expensive, due in part to significant overheads required for processing and storage of video data.

Current video recognition systems with built-in video recognition must store raw video data (i.e. video data which has not been compressed) if the video data is to be retrospectively searched for specific characteristics and events. This is because high quality images are required to provide the most effective searching and recognition of characteristics within the video data.

Raw video data is large and substantial processing power is required to search the data for specific characteristics or events. This makes current systems and methods unsuitable for implementation in a client-server hierarchy across network connections where bandwidth is limited. Also systems developed for domestic use are complex and expensive and can therefore not be readily implemented by a domestic user. These problems are exacerbated when multiple connections from multiple clients are required and multiple search requests for specific characteristics and/or events are received by a single server acting as a video processing device.

It is also not possible to implement complex and processor intensive video searching on portable devices, for example mobile telephones.

### SUMMARY OF THE INVENTION

The present invention aims to address the aforementioned problems.

The present invention is defined in the appendant claims.

In a first aspect, the present invention provides a method of transferring video data, comprising:

(a1) obtaining a stream of video frames from a video capture device;

(b1) identifying at least one characteristic in at least one frame of the stream of video frames;

(c1) generating lookup data which associates the at least one characteristic with each video frame in which the at least one characteristic is identified;

(d1) storing a subset of the stream of video frames and lookup data in memory of the video processing device;

(e1) receiving a search query of a given characteristic from a client;

(f1) determining, from the lookup data, the at least one video frame in the subset of the stream of video frames having the given characteristic; and

(g1) transmitting the at least one video frame corresponding to the given characteristic from the subset of video frames to the client.

In this way, characteristics which are to be searched for in the stream of video frames are pre-defined so that the characteristics can be identified and the raw stream of video frames can then be stored in a reduced format alongside the lookup data. Hence, the ability to search for characteristics within the reduced video stream at a later time can be maintained and the video data does not need to be stored as raw data having a substantial memory overhead for storage and bandwidth overhead for transmission.

Each video frame can be an image and the stream of video frames can be a sequential stream of images captured by the video processing device. The frame capture rate can be set so that the images, when viewed sequentially, appear as discrete images. Alternatively, when storing a subset of the video frames, the frame interval between the images can be set so that the images appear as discrete images when viewed sequentially at a later time. In such a way, the step of storing a subset of the stream of video frames reduces the frame rate of video data.

Preferably, the step of storing comprises: compressing the stream of video frames by applying a video compression algorithm to the stream of video frames. An example of such a compression routine is the MPEG-2 codec.

Subsequently, the method may comprise:

(f2) transmitting an identification address for each frame in the stream of video frames having the given characteristic; and

(f3) receiving an identification address from the client for at least one frame having the given characteristic,

wherein step (g1) comprises transmitting the at least one video frame corresponding to the received identification address.

Preferably, the method includes the further step of:

(f2-a) displaying the identification address as a selectable link on a display screen of the client,

wherein the step of receiving comprises receiving the identification address corresponding to a link selected by a user of the client.

The identification address may be a universal resource locator (URL).

The characteristic may be a given colour in one video frame of the stream of video frames. The colour may be specified as a range of colours having Red Green Blue (RGB) values within a particular range.

The characteristic may include the presence of motion of an element between successive video frames received from the video capture device. Alternatively, the characteristic may include a particular pre-defined type of motion.

Preferably, the given characteristic is identified in a given section of each frame in the stream of video frames.

In one embodiment of the present invention, the method further comprises:

(a2) receiving at the video processing device a request for a characteristic to be identified in the stream of video frames during step (b1).

In a second aspect of the present invention, there is provided a video processing device, comprising:

memory adapted to store a stream of video frames received from a video capture device;

a processor connected to the memory and configured to identify at least one characteristic in at least one frame of the plurality of frames, generate lookup data which associates the at least one frame with the characteristic, store a subset of the stream of video frames and lookup data in the memory and determine from the lookup data, the at least one frame in the subset of the stream of video frames having a given characteristic; and

a network interface connected to the processor configured to receive a search query from a client for the given characteristic and transmit the at least one video frame corresponding to the given characteristic from the subset of video frames to the client.

The video processing device may be implemented as a web server. In one embodiment, the network interface of such a server is configured to receive a single client connection. Thus, the video processing device is advantageously adapted for use in a domestic environment which has limited network infrastructure.

In a third aspect of the present invention, there is provided a video transfer system comprising:

the aforementioned video processing device;

a client connected to the video processing device by a network connection; and

a video capture device connected to the video processing device.

Preferably, the video capture device is a closed-circuit video camera.

Advantageously, the client may be a mobile telephone in which the network connection is implemented via wireless application protocol (WAP) over General Packet Radio Service (GPRS). Other wireless data transfer protocols, including third generation (3G) and Worldwide Interoperability for Microwave Access (WiMAX), are contemplated.

The network connection can be a connection to the Internet.

In a fourth aspect of the present invention, there is provided a method of image identification, comprising:

(a1) receiving, at a video processing device from a client, a criterion for a given characteristic of an image in a stream of video frames;

(b1) subsequently, obtaining a stream of video frames from an video capture device;

(c1) identifying, at the server, the given characteristic in at least one image of the stream of video frames by:
generating lookup data which associates at least one image from the stream of video frames with the given characteristic;
storing the stream of video frames and lookup data on a server; and
determining, from the lookup data, the at least one image in the stream of video frames having the given characteristic,

(d1) sending a notification to the client that the given characteristic has been detected in at least one image of the stream of video frames.

This way, an alarm for a specific event detected in the video frames can be preset. For example, when the video processing device is installed in a domestic environment, the video capture device could be directed towards a front door. An alarm to notify a parent at their mobile phone when a child returns home could be preset by specifying detection of a particular colour entering through the front door.

Advantageously, the notification may include at least one image having the given characteristic.

The notification may comprise an identification address for the at least one image in the stream of video frames having the given characteristic.

The method may further comprise:

(e1) displaying the identification address as selectable link on a display screen of the client;

(f1) receiving, at the video processing device, a selected identification address from the client for an image having the given characteristic; and

(g1) transmitting the image having the given characteristic from the video processing device to the client.

In this way, the image does not need to be transmitted to the client unless the client specifically requests that this is done.

In a fifth aspect of the present invention, there is provided a video processing device, comprising:

memory adapted to store a stream of video frames received from a video capture device;

a processor connected to the memory and configured to identify a given characteristic in at least one image of the plurality of frames by generating lookup data which associates at least one image from the stream of video frames with the given characteristic, storing the stream of video frames and lookup data on a server, and determining, from the lookup data, the at least one image in the stream of video frames having the given characteristic; and

a network interface connected to the processor configured to receive a search query from a client for the given characteristic and transmit a notification to the client that the given characteristic has been detected in at least one image of the stream of video frames.

In a sixth aspect of the present invention, there is provided a method of image identification, comprising:

(a1) obtaining a stream of video frames from an video capture device at a first video processing device;

(b1) identifying, at the first video processing device, at least one characteristic in at least one image of the stream of video frames;

(c1) generating, at the first video processing device, lookup data which associates the at least one image with the characteristic;

(d1) storing the stream of video frames and lookup data on the second video processing device;

(e1) receiving, at the second video processing device, a search query for a given characteristic from a client;

(f1) determining, from the lookup data at the second video processing device, the at least one image in the stream of video frames having the given characteristic; and

(g1) transmitting the at least one image to the client from the second video processing device.

Preferably, step (c1) comprises storing the lookup data and stream of video frames in memory at the first video processing device and step (d1) comprises transmitting the stored lookup data and stream of video frames from the first video processing device to the second video processing device across a network connection.

Advantageously, the step of compressing may comprise storing only a subset of images from the stream of video frames at the first video processing device and the second video processing device. Each image can be digitally signed to prevent them being tampered with once they have been generated. This is useful in CCTV implementations in which it is desirable to use compressed images as evidence in criminal court proceedings. One suitable compression technique is JPEG (Joint Photographic Experts Group) compression. JPEG compression allows individual images to be digitally signed. Alternatively, the entire video stream may be compressed using real-time motion video compression such as MPEG (Moving Picture Experts Group) encoding.

In this way, the stream of video frames can be processed for recognised characteristics and reduced at one processing device before transmitting the reduced set of data to a second video processing device at which the data is stored for access by one or more clients. This means that the processing burden is confined to a dedicated device and a relatively small amount of data can be transmitted to and stored at a second device whilst still offering the ability to search the reduced set of data for pre-defined characteristics using look-up data stored at the second processing device.

Preferably, the step of transmitting the at least one image comprises transmitting a section of the compressed video data to the client from the second video processing device.

The method may further comprise:

(f2) transmitting, from the second video processing device, an identification address for each image in the stream of video frames having the given characteristic; and

(f3) receiving, at the second video processing device, an identification address from the client for at least one image having the given characteristic, wherein the step of transmitting comprises transmitting the at least one image corresponding to the received identification address.

Advantageously, the second video processing device is configured to receive a plurality of search queries from a plurality of clients and steps (e1) to (g1) are performed at the second video processing device independently for each received search query.

Preferably, the first video processing device is included in a first server configured to receive data from and transmit data to a single client connection and the second video processing device is included in a second server configured to receive data from and transmit data to multiple clients.

In a seventh aspect of the present invention, there is provided a video transfer system comprising:

a first video processing device configured to obtain a stream of video frames from a video capture device, identify at least one characteristic in at least one image of the stream of video frames and generating lookup data which associates the at least one image with the characteristic; and

a second video processing device connected to the first video processing device across a network connection and configured to store the stream of video frames and lookup data in second memory, receive a search query from a client for a given characteristic in the stream of video frames and determine, from the lookup data, the at least one image in the stream of video frames having the given characteristic and transmit the at least one image to the client.

The first processing device may be configured to store in first memory the lookup data and stream of video frames and transmit the lookup data and stream of video frames to the second video processing device across the network connection.

In an eighth aspect of the present invention, there is provided a method of transferring video data, comprising:

(a1) obtaining a stream of video frames from a video capture device;

(b1) identifying at least one characteristic corresponding to at least one frame of the stream of video frames;

(c1) generating lookup data which associates the at least one characteristic with each video frame in which the at least one characteristic is identified;

(d1) storing a subset of the stream of video frames and lookup data in memory of the video processing device;

(e1) receiving a search query of a given characteristic from a client; and

(f1) determining, from the lookup data, the at least one video frame in the subset of the stream of video frames corresponding to the given characteristic.

The step of identifying may include identifying the presence of given colour in one video frame of the stream of video frames. In addition, the step of identifying may include detecting motion of an element between successive video frames received from the video capture device.

The step of identifying may comprise identifying the given characteristic in a given segment of one or more of the video frames.

The characteristic need not necessarily be contained in the captured video frame. In one embodiment, the step of identifying includes detecting the presence of a given sound with a sound detector connected to the video processing device. In addition, the step of identifying may include detecting the presence of a given odor with an odor detector connected to the video processing device. Such characteristics are examples of characteristics which are not simply related to characteristics in a captured video frame and any sensed characteristics which can be associated with a captured video frame are contemplated by the present invention.

The search query can also comprise an indication of a range of times of day for frames identified in the lookup data from which the at least one video frame in the subset of the stream of video frames corresponding to the given characteristic is to be determined.

Advantageously, the search query can include a combination of specified characteristics and the step of determining then comprises determining, from the lookup data, at least one video frame in the subset of the stream of video frames having the combination of specified characteristics in the lookup data. In this way, a combination of specified characteristics can define a specific event which is detectable by the video processing device. For example, the presence of the colour red moving into a particular segment of a video frame in conjunction with detection of the sound of engine noise could specify the event of a postal van arriving in the field of view of the video capture device.

The combination of specified characteristics may be specified by a boolean combination of given characteristics. For example, a boolean combination might be: [the presence of a specific colour AND a specified noise] OR motion in a particular segment of the captured video frame.

In one embodiment, the video processing device may be configured to store one or more pre-defined combinations of specified characteristics in its memory with an contextual description of the combination. The search query may then comprise a flag to one of the pre-defined combinations of specified characteristics stored in memory of the video processing device and the step of determining comprises obtaining the pre-defined combination of specified characteristics corresponding to the flag from the memory and identifying at least one video frame in the subset of the stream of video frames corresponding to the obtained pre-defined combination. In this way, the video processing device can transmit a list of stored pre-defined combinations with contextual descriptions to the client. A user of the client can select one of the contextual descriptions at the client which transmits a flag for the contextual description back to the video processing device as the search query. This means that complex combinations of specified characteristics representing specific detectable events can be maintained at the video processing device, but still be easily recognisable at a client by its contextual description, which might be an event title (e.g. “husband arrives home”, “postal delivery” etc.). Moreover, generation of a complex search query does not need to then be carried out at a client which is especially advantageous if the client is a portable device, such as a mobile phone. The pre-defined search queries can be defined at a computer terminal client prior to accessing the video processing device with a mobile terminal.

The flag is any information that can identify a specific pre-defined combination of specified characteristics stored at the video processing device. For example, the search query may be a URL from a hyperlink which is selected at the client and transmitted to the video processing device.

A plurality of hyperlinks, each corresponding to a pre-defined combination of specified characteristics may be obtained from video processing device and displayed by the client. Each hyperlink is displayed with the contextual description corresponding to the pre-defined combination of specified characteristics. The URL represented by each hyperlink contains the flag representing the pre-defined combination of specified characteristics. Thus, when a user selects one of the hyperlinks, its URL (containing a flag) is transmitted to the video processing device. The URL thus constitutes a search query.

In a ninth aspect of the present invention, there is provided a video processing device, comprising:

memory adapted to store a stream of video frames received from a video capture device;

a processor connected to the memory and configured to identify at least one characteristic corresponding to at least one frame of the plurality of frames, generate lookup data which associates the at least one frame with the characteristic, store a subset of the stream of video frames and lookup data in the memory and determine from the lookup data, at least one frame in the subset of the stream of video frames having corresponding to the given characteristic; and

a network interface connected to the processor configured to receive a search query from a client for the given characteristic.

The processor may be configured to identify the presence of given colour in one video frame of the stream of video frames. In addition, the processor may be configured to detect motion of an element between successive video frames received from the video capture device. The processor may be configured to identify the given characteristic in a given segment of one or more of the video frames. In this regard, the processor may execute specific video recognition algorithms corresponding to the type of video information being identified.

In one embodiment of the present invention, the video processing device may further comprise a sound detector connected to the processor, wherein the processor is configured to detect the presence of a given sound as one of the characteristics. In this regard, the processor may execute specific sound recognition algorithms which are well-known to a person skilled in the art. In addition, the video processing device may further comprise an odor detector connected to the processor, wherein the processor is configured to detect the presence of a given odor as one of the characteristics. In this regard, the processor may execute specific odor recognition algorithms which are well-known to a person skilled in the art.

Preferably, the processor may be configured to determine, from the lookup data, at least one video frame in the subset of the stream of video frames having the combination of specified characteristics in the lookup data. The memory may be adapted to store one or more pre-defined combinations of specified characteristics.

Advantageously, the search query may comprise a flag to one of the pre-defined combinations of specified characteristics stored in memory of the video processing device and the processor is configured to obtain the pre-defined combination of specified characteristics corresponding to the flag from the memory and identify at least one video frame in the subset of the stream of video frames corresponding to the obtained pre-defined combination.

### BRIEF DESCRIPTION OF THE DRAWINGS

By way of example, the present invention is described below with reference to the accompanying drawings, in which:—

FIG. 1 shows a representation of a system including a video processing device according to one embodiment of the present invention;

FIG. 2 shows a representation of the structure of data stored in memory of a video processing device of the prior art;

FIG. 3 shows a representation of a video frame captured according to the embodiment of the invention in FIG. 1;

FIG. 4 shows a representation of the structure of data stored in memory of a video processing device according to the invention;

FIG. 5 shows a flow diagram of steps performed by the video processing device according to one embodiment of the invention;

FIG. 6 shows a flow diagram of steps performed by the video processing device and an additional video processing device according to a second embodiment of the invention;

FIG. 7a shows a front perspective view of the video processing device according to one embodiment of the invention;

FIG. 7b shows a rear perspective view of the video processing device of FIG. 7a;

FIGS. 8 to 13 show representations of a user interface presented to a user by software executing on a client device according to one embodiment of the invention;

FIG. 14 shows a representation of a search query being generated via a user interface implemented through a web browser according to an alternative embodiment of the invention; and

FIGS. 15a, 15b and 15c show representations of a search query being generated in a user interface implemented by client software executing at a mobile client according to yet another alternative embodiment of the invention.

FIGS. 16a, 16b and 16c show the representations of and interrelationship between a captured video frame, lookup data and a search query according to one embodiment of the invention.

### DETAILED DESCRIPTION OF THE DRAWINGS

A specific embodiment of the present invention is now described.

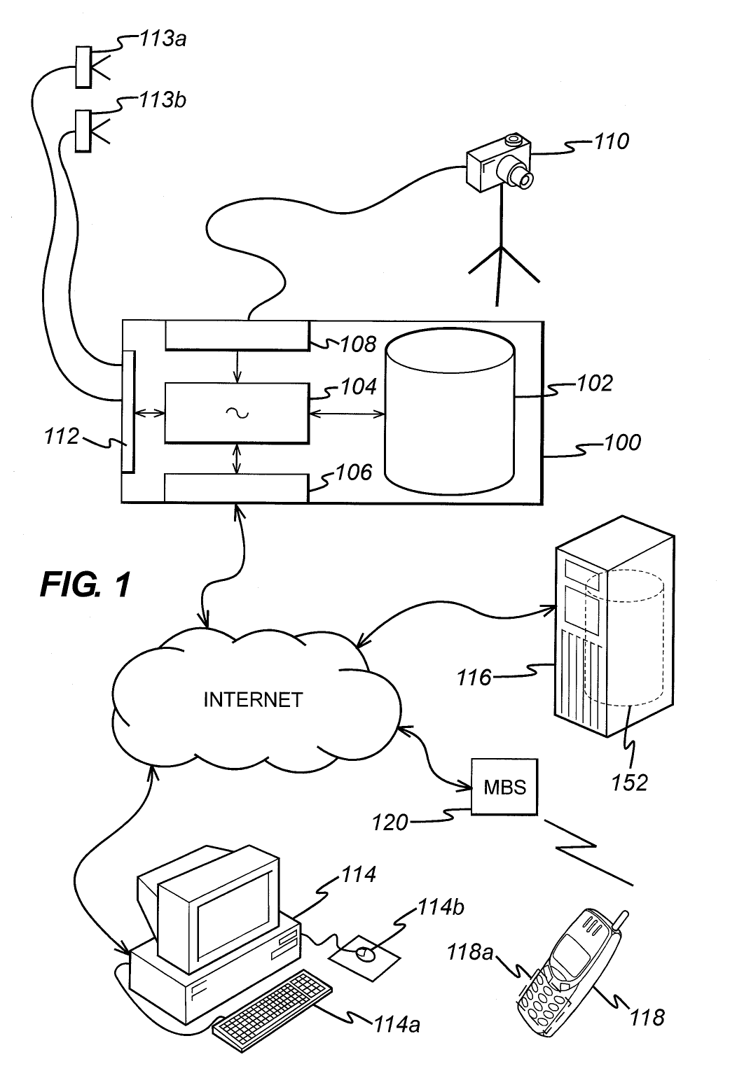

FIG. 1 shows a video processing device 100 which includes memory 102 connected to a processor 104. The processor 104 is connected by way of data bus to a network interface 106 and a video interface 108. The video interface 108 interfaces a video capture device 110 to the processor 104 and allows the processor 104 to receive streamed images from the video capture device 110.

An I/O interface 112 is connected to the processor 104 and permits connection of additional sensors 113a, 113b to the video processing device 100, such as a sound detector 113a and an odor detector 113b.

The network interface 106 connects the processor 104 to the Internet 112 by any conventional network connection, such as Point of Presence (PoP) implementing a PSTN or ISDN dial-up, Asymmetric Digital Subscriber Line (ADSL) or fixed-line/wireless Ethernet.

Also connected to the Internet 112 are: a client terminal 114, a server 116 and a mobile terminal 118 which is connected via a wireless cellular connection to a Mobile Base Station (MBS) 120 itself connected to the Internet 112.

The client terminal 114 and mobile terminal 118 provide user access through the Internet 112 via web browser software executing on the client terminal 114 or mobile terminal 118 to the video processing device 100.

Alternatively, the client terminal 114 and mobile terminal 118 execute custom-installed software which provide a user interface for accessing features via the Internet 118 of the video processing device 100.

As will be known, the Internet 112 is a packet-switched Wide Area Network (WAN) of interconnected computers and sub-networks. The Internet 112 relies on Transmission Control Protocol (TCP)/Internet Protocol (IP) to transmit data and requests for data from a source to a destination.

As will also be known, a web browser accepts user input at the client terminal 114 from a keyboard 114a and a pointing device 114b or at the mobile terminal 116 from a keypad 118a and transmits requests over the Internet for web pages and other data to server devices connected to the Internet 112. Each server device is identified at the client or mobile terminal 114, 118 by specifying a unique address, such as a Uniform Resource Locator (URL). When a server device receives a request for data, it obtains data from memory connected to it and transmits the obtained data across the Internet 112 to the requesting client or mobile terminal 114, 116. A user can interact with the received data via the web browser at the client or mobile terminal 114, 118. The data can be text-based pages in Hypertext Markup Language (HTML) with embedded images which are individually requested from a server device by the client terminal. Alternatively, the images and/or video data can be streamed directly from the server device to the client terminal and displayed in the terminal's web browser or the user interface generated by the custom-installed software executing at the terminal 114, 118.

The memory 102 of the video processing device 100 includes both Integrated Circuit (IC) based Random Access Memory (RAM) and sequential memory in the form of hard disk type memory. For the purposes of the discussion below, “memory” includes one or more of these types of memory.

The processor 104 executes computer executable instructions stored in the memory 102. The computer executable instructions enable the processor 104 to interact with image data received via the video interface 108 and to transmit and receive data via the network interface 106 as well as to process data stored in the memory 102. The operation of the processor 104 in conjunction with the computer executable instructions will be described in further detail below.

The video capture device 110 is any form of video capture apparatus, for example a video camera including a charge-coupled device (CCD) which outputs an analogue video signal of streamed video frames.

The sound detector 113a is any form of sound detection apparatus, for example a directional microphone configured to receive sound from the field-of-view of the video capture device 110.

The odor detector 113b is any form of odor detection apparatus, for example a chemical sensor configured to detect a particular gas (e.g. carbon monoxide) or particulate (e.g. smoke).

The server 116 acts as a second video processing device as will be described below.

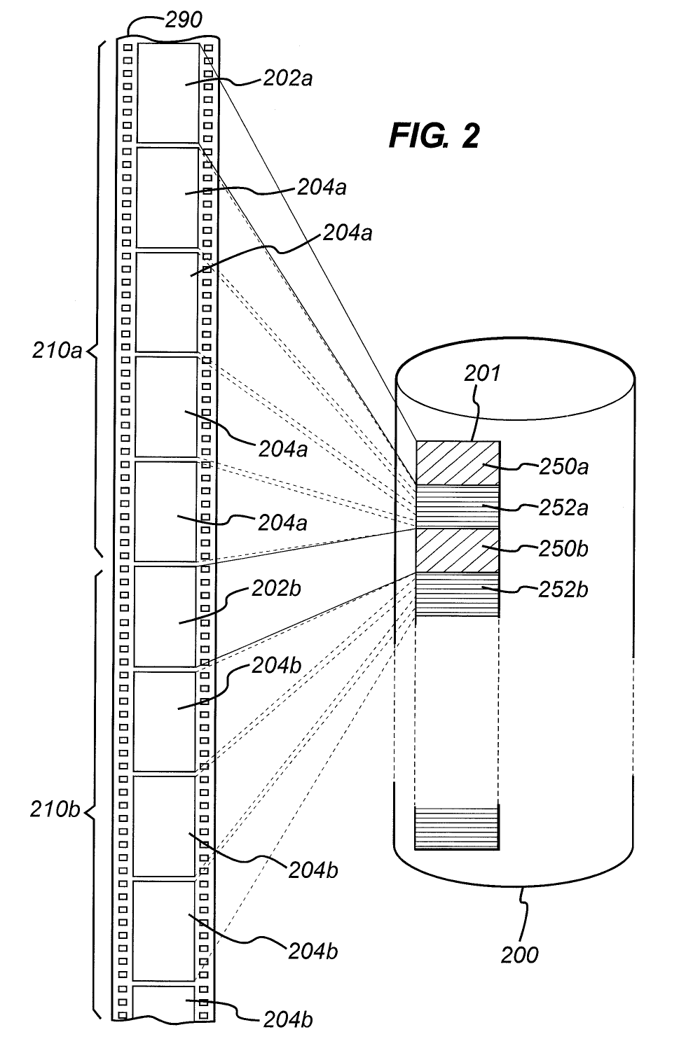

FIG. 2 shows a simplified representation of memory 200 of a conventional digital video storage device in which individual video frames 202a, 202b of raw digital data are stored in the memory 200 as sequential elements of compressed digital data 201. An initial frame 202a, 202b in a Group of Pictures (GOP) is spatially compressed and stored as initial data 252a, 252b in the memory 200. Subsequent frames in each GOP are temporally compressed based on each initial frame 202a, 202b and stored as secondary data following the initial data 252a, 252b for the GOP. The data 201 has to be decompressed to reconstruct the original video data stream.

One suitable compression/decompression technique is the MPEG-2 codec (Moving Picture Experts Group).

As a result of the data compression/decompression, the decompressed digital data stream is likely to be of reduced quality and therefore less suitable for image recognition processing than the original raw digital data output from a video capture device. Conversely, storing raw digital data as uncompressed data requires substantial storage capability in a conventional digital video storage device and significant bandwidth overheads in a network-based video processing device.

The present invention aims to alleviate the aforementioned problems by providing a video processing device which allows data to be stored and transmitted over a network as compressed data whilst maintaining the accuracy of image recognition available from processing raw uncompressed digital video data.

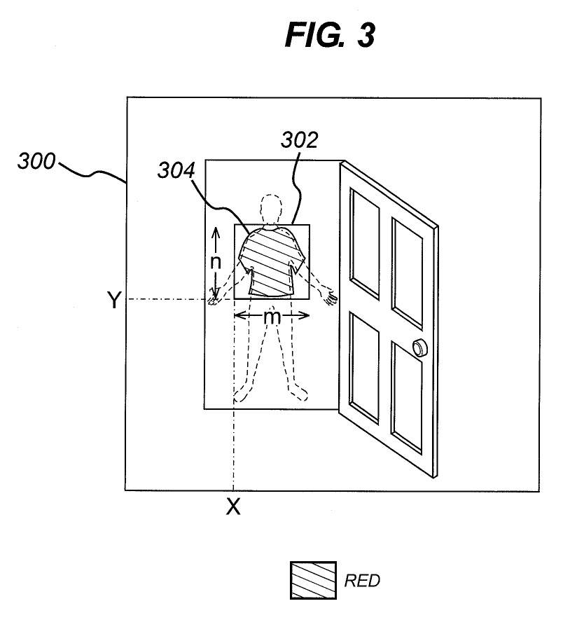

FIG. 3 shows a representation of one frame 300 of a sequential number of video frames according to one embodiment of the invention. The frame 300 is analysed by the video processing device 100 of the present invention which examines a sample area 302 of each frame 300. The sample area 302 depicted in FIG. 3 is in the shape of a square section. However, it will be appreciated that the sample area 302 may take the form of any predefined shape.

In one embodiment of the present invention, the location of the sample area 302 within the video frame 300 is specified with reference to coordinates X, Y. For each sample area 302, there are one or more associated image events which are searched for within the sample area 302. Each image event is then specified in terms of an identifiable threshold characteristic of an image frame, for example: the number of pixels within the sample area having a colour within a given range of colours.

For each defined sample area, there are the following associated parameters:—
X, Y position;
shape of sample area;
size of sample area;
one or more image events;
one or more alarms.

The sample area parameters are stored in the memory 102 of the video processing device 200. The sample area parameters are set from the client or mobile terminal 114, 118 via the terminal user interface and constitute a criterion for generating the lookup data.

In the example shown in FIG. 3, the sample area parameters would be the X, Y position of the sample area having a square shape of size m×n and 60% of the pixels within the sample area having, for example, a red colour (specified by a range of colour values). Alternatively, the image event could be the presence or movement between sequential images of an identifiable shape within the sample area 302.

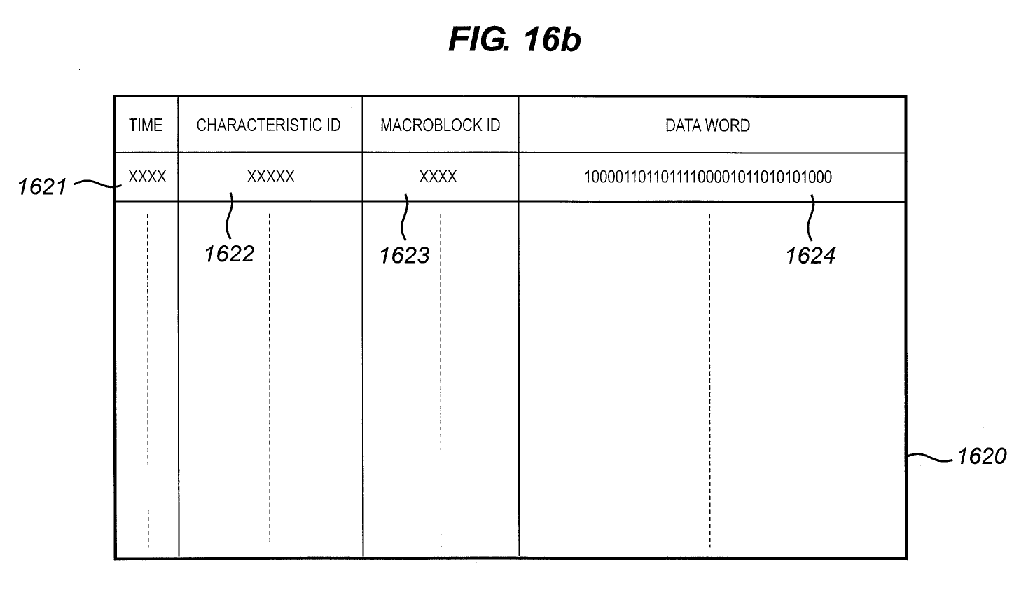

In an alternative embodiment of the invention, the sample area 302 may be defined with reference to macro block and micro block regions of the video frame 300. This is described in further detail below with reference to FIG. 16a.

Each frame in a sequence of frames is analysed according to each sample area 302 stored in the memory 102 to determine whether one or more image events occurs in the sequence of video frames. If an image event is detected, then the alarm for the particular sample area is generated. An alarm is defined as a particular action which is taken by the video processing unit 100, for example transmitting the image data for the frame in which the event is detected to the client or mobile terminal 114, 118.

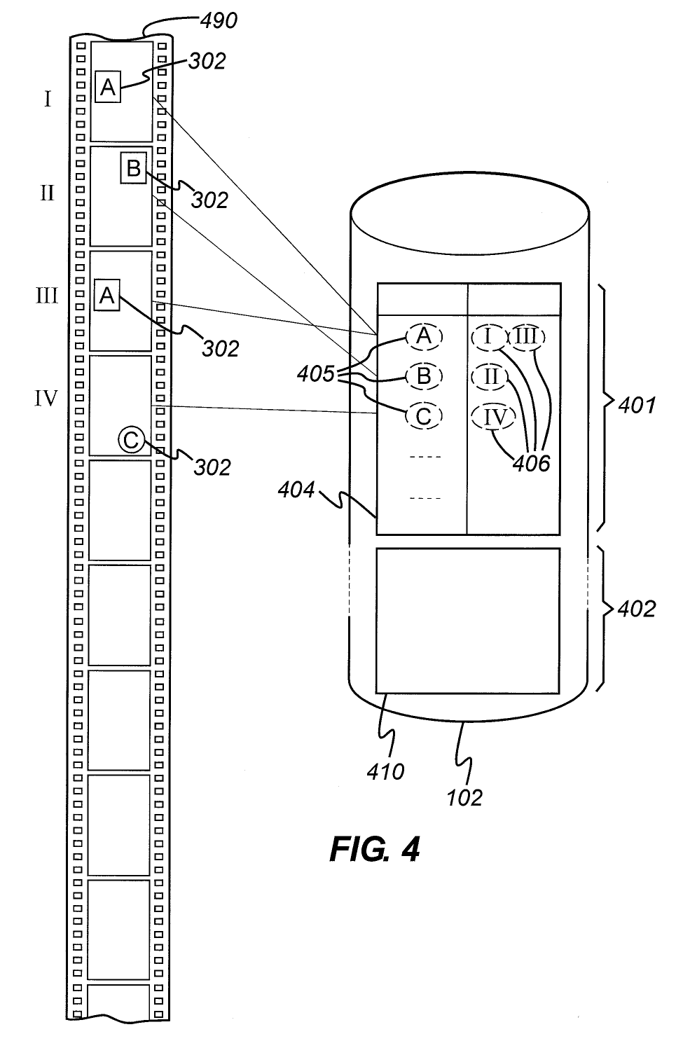

FIG. 4 shows a representation of video data stored in memory 202 in accordance with the present invention.

In a first area 401 of the memory 102, a lookup table 404 is generated with a reference 405 to each defined sample area 302. Associated with each reference 405 is a frame identifier 406 identifying each frame which possesses one or more of the image characteristics corresponding to the sample area 302 associated with the reference 405. The lookup table 404 is generated on-the-fly from raw digital video data obtained from the video capture device 110 described below.

In a second area 402 of the memory 102, compressed video data 410 is stored in conjunction with the lookup table 404.

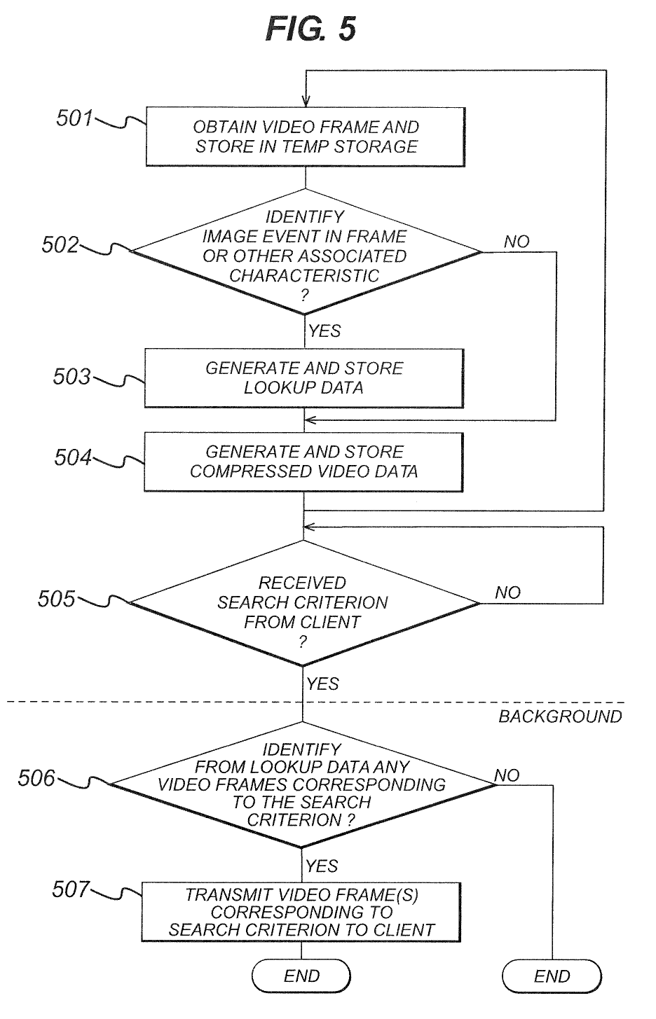

FIG. 5 shows the steps performed by the processor executing computer-executable instructions in accordance with one embodiment of the invention for processing video data received from the video capture device 110 in a video recognition process 500. Of course, it will be appreciated that identical steps will be carried out for each video capture device 110 connected to the video processing device 100.

In step 501, the processor 104 obtains a stream of video frames from the video capture device 110. The video frames are temporarily buffered in a temporary storage area of the memory 102 whilst being processed in the steps described below.

In step 502, the processor 104 identifies whether at least one characteristic in at least one frame of the stream of video frames is present by applying one or more sample areas to each frame and determining whether one or more specified image characteristics (or image events) is present in each sample. The processor 104 carries out the identification step by executing one or more video processing algorithms (stored in the memory 102) on the video frame data.

In addition, the processor 104 analyses the signals from the additional sensors 113a, 113b to determine if an additional sensory characteristic can be detected. For example, if sensor 113a is a sound detector, the processor analyses the signals from the sound detector to determine whether a given sound has been generated (e.g. engine noise, the sound of a baby crying etc.). The particular additional sensory characteristics that are detectable are stored in the memory 102 along with detection algorithms executable by the processor 104 for detecting particular types of characteristics dependant on the type of sensor.

The processor 104 can multi-task the execution of the video processing and detection algorithms whilst each frame is being processed.

The applied sample areas are obtained by the processor 104 from the memory 102 of the video processing device 100 having been previously stored in the memory 102 from settings received from the client or mobile terminal 114, 118.

In step 503, lookup data 404 is generated which associates each identified characteristic (either a video characteristic or alternative associated characteristic) with a corresponding video frame from the time when the characteristic was identified. If the identified characteristic is identified from a video frame having the characteristic, then that particular video frame will be used as a reference for the identified characteristic in the lookup data 404. If the identified characteristic is an associated characteristic, such as sound or smell, then the video frame which was captured at the time the associated characteristic was first detected is used as a reference for the associated characteristic in the lookup data 404. The lookup data 404 is stored and updated in the memory 102.

The lookup data may be stored in a data file as eXtended Markup Language (XML). As the lookup data 404 is generated, the raw digital video data for video frames which have been analysed are removed from the temporary area of the memory 102.

In step 504, a subset of the stream of video frames is stored in the memory 102 by compressing the stream of video frames to remove redundant frames or by applying a video compression algorithm (e.g. MPEG-2). The lookup data 404 is also stored in the memory 102.

In step 505, a search query of a given characteristic from a client is received from the client terminal 114 or mobile terminal 118. The search query contains a desired image characteristic, a location reference corresponding to one or more coordinate locations within the image frame to search for the desired image characteristic and a range of times through which the desired image characteristic should be searched for. Alternatively, the search query contains a desired associated characteristic and a range of times through which the desired associated characteristic should be searched for in the lookup data. In another embodiment, the search query contains a combination of desired image characteristics and associated characteristics that are to be searched for as occurring at the same time or separately. Such a query may be formulated with Boolean logic. In yet another embodiment, the search query may simply contain a flag to a pre-defined combination of image and associated characteristics that have been previously stored in the memory 102 of the video processing device 100. In a further embodiment, the search query may simply contain a flag indicating that all identified image and associated characteristics are to be searched for in the lookup data 404.

In step 506, video frames in the subset of the stream of video frames referenced in the lookup data 404 for the given characteristic(s) are identified.

In step 507, each video frame corresponding to the given characteristic(s) from the subset of video frames is transmitted to the client or mobile terminal 114, 118.

As shown, steps 506 and 507 are carried out in parallel with the video processing steps 501 to 505.

In an alternative embodiment, in step 507, instead of transmitting one or more frames which have been identified, the video processing device 100 may transmit a notification to the client or mobile terminal 114, 118 that the given characteristic(s) have been identified in the lookup data. In this case, the video processing device 100 may transmit an identification address to the client or mobile terminal 114, 118 for each frame in the stream of video frames having the given characteristic and wait for one or more of the identification addresses to be received back from the client or mobile terminal 114, 118 before sending only the video frame which corresponds to a received identification address to the client or mobile terminal 114, 118.

The identification address may be in the form of a hyperlink displayed by a web browser in a display screen of the client or mobile terminal 114, 118. The hyperlink contains a universal resource locator (URL) including an Internet address for the video processing device and the location and name of an image for the selected frame stored in the memory 102.

In a further implementation of the embodiment of FIG. 5, prior to the identification of characteristics (i.e. step 502), the video processing device 100 receives one or more requests in the form of an identification criterion for a particular characteristic to be identified during processing of the video frames. If the request relates to defining an image characteristic, the request defines one or more sample areas 302, each having specific parameters relating to the size, shape and position of the sample area and a specific event which is to be identified in step 502. The request may be transmitted from the client or mobile terminal 114, 118. This implementation is particularly advantageous in the situation where a mobile terminal 118 is used as the client device for transmitting a search query during step 505 because a client terminal 114 can be used to set pre-defined identification criteria, for example before a user leaves their house at which the video processing device 100 is located. The mobile terminal 118, having a small screen and keypad 118a, is less suited to setting the identification criteria or providing custom-defined search criteria. In this scenario, when it is desired to use the mobile terminal 118 to transmit search criteria to the video processing device 100, the mobile terminal 118 can receive one or more of the pre-defined identification criteria from the video processing device 100 and a user can select one or more of the pre-defined identification criteria using the mobile terminal 118 without having to use the mobile terminal 118 to setup a search query.

The characteristic can include: a given colour in one video frame of the stream of video frames or motion of an element between successive video frames received from the video processing device 100.

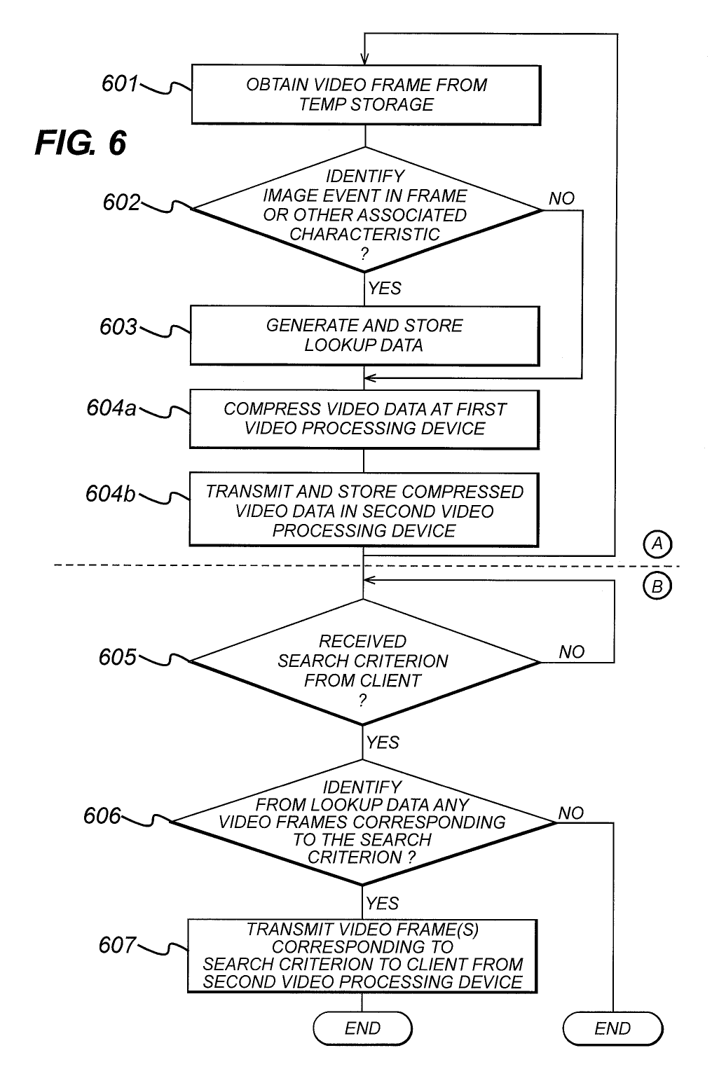

FIG. 6 shows the steps performed by the processor 104 executing computer-executable instructions in an alternative video recognition process 600 in accordance with a second embodiment of the invention.

In step 601, a stream of video frames is obtained from a video capture device at a first video processing device 100.

In step 602, an image characteristic in at least one image of the stream of video frames is identified at the first video processing device 100 and associated characteristics are also identified.

In step 603, lookup data is generated at the first video processing device which associates the at least one image with the image characteristic or associated characteristic.

In step 604a, the stream of video frames is compressed as it is received at a first video processing device 100.

In step 604b, the lookup data 404 and compressed stream of video frames is transmitted to and stored in memory 152 of a second video processing device 116.

In step 605, the second video processing device 116 receives a search query for a given image characteristic, a given associated characteristic, combination thereof or a pre-defined search query stored in the memory 152 of the second video processing device 116, from a client or mobile terminal 114, 118. If the search query relates to an image characteristic, the search query contains a desired image characteristic, a location reference corresponding to one or more coordinate locations within the image frame to search for the desired image characteristic and a range of times through which the desired image characteristic should be searched for.

In step 606, the second video processing device 116 determines, from the lookup data 404 stored in the memory 152 at the second video processing device 116, one or more images in the stream of video frames that correspond to the given characteristic(s).

In step 607, at least one image corresponding to the identified image is transmitted to the client or mobile terminal 114, 118 from the second video processing device 116. The second video processing device 116 may transmit a number of sequential images of a section of video corresponding to the identified image.

Steps 601 to 604b are carried out at the first video processing device 100 (marked as (A) in FIG. 6). At the same time, steps 605 to 607 are carried out at the second video processing device 116 (marked as (B) in FIG. 6).

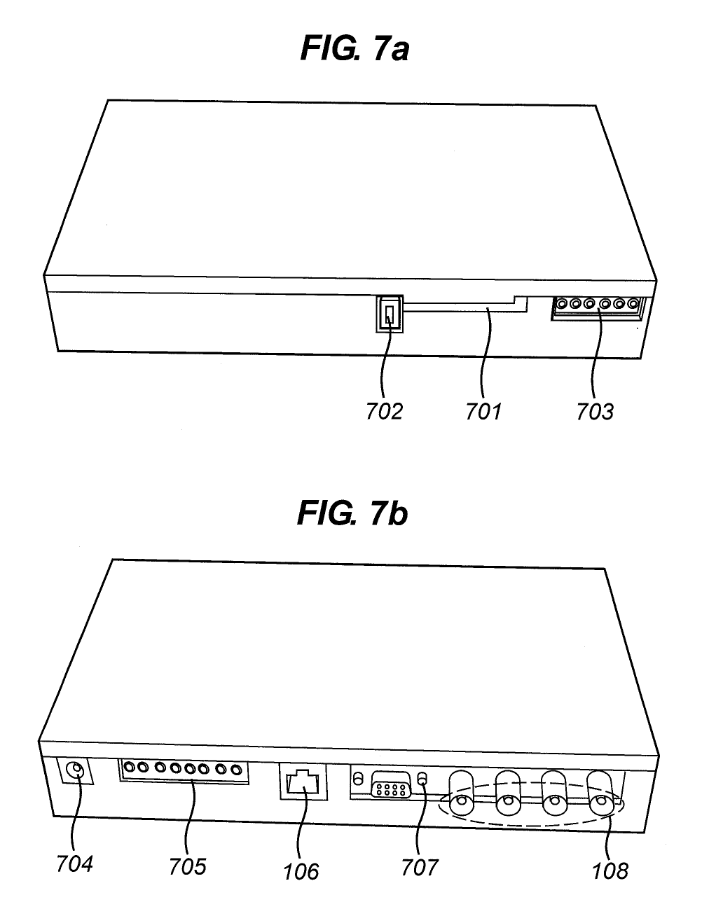

FIG. 7a shows external features of the video processing device 100. The network interface is shown as a USB port for permitting a broadband modem or Ethernet router to be connected to the video processing device 100. The video processing device 100 also includes: —
Light Emitting Diodes (LEDs) 701 indicating the operation of the video processing device 100;
a reset button 702 for resetting the power supply to the video processing device 100; and
input/outputs 703 which permit the processing device 100 to communicate with additional sensors 113a, 113b and/or external alarms/triggers and other systems.

FIG. 7b shows additional external features of the video processing device, including:
a power connector (nominally a 24 V DC power supply rated up to 1.67 A) 704;
opto-isolated inputs 705 which allow the video processing device to communicate with other sensors and systems;
the network interface 106 which is implemented by an RJ-45 (Ethernet) connection for connecting the video processing device to an Ethernet network;
a camera control connector (RS485) 707 for a serial link to a Pan Tilt Zoom (PTZ) camera thereby allowing the processor 104 to control and move the camera; and
the video interface 108 formed from composite video BNCs which are video inputs to the video processing device 100 from video capture devices/cameras and accept any composite video signal in a phase-alternating line (PAL) format.

Connecting power to the power connector initiates the video processing device 100 by having the processor 104 execute a boot-up procedure (which does not take more than one minute). Application of a video signal to the video interface 108 causes the processor 104 to commence the video recognition process 500/600. As soon as a video source is connected to the video interface 108, the processor commences video capture.

The video processing device 100 is only accessible via Secure Hyper Text Transfer Protocol (HTTPS) and not HTTP.

The video processing device 100 is preconfigured with the following, factory set

network parameters:—

IP address: 192.168.110.22

Network mask: 255.255.255.0

Default gateway: 192.168.110.1

In order to change the networking parameters for the first time, the following steps have to be followed:—

1. Connect the video processing device 100 to a host terminal using a crossed Ethernet cable (back-to-back connection).
2. Configure the host terminal to have the following IP address and network mask:—
IP address: 192.168.110.23 and network mask: 255.255.255.0
3. A web browser running on the host terminal can be used to browse to the following address: https://192.168.110.22:10000.
4. Upon successful authentication by the processor 104, a ‘networking’ tab/link can be activated to view and edit network configuration settings of the video processing device 100.

After the network configuration settings have been changed, the video processing device 100 can be connected to a target network via the network interface 106, the target network itself connected to, for example, the Internet.

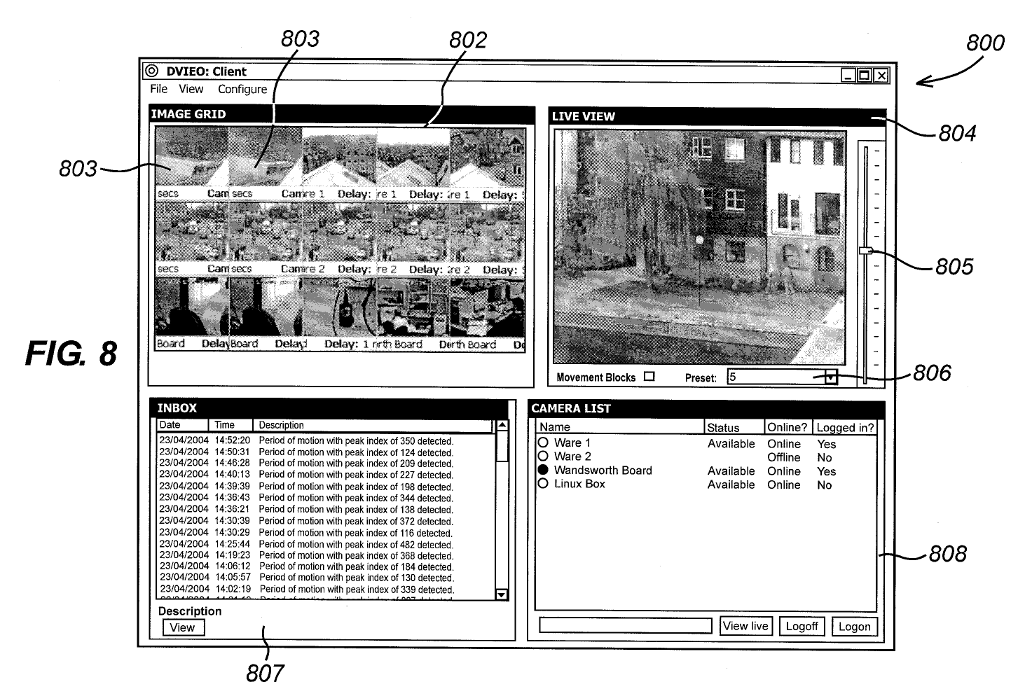

FIG. 8 shows a representation of a user interface 800 provided by custom software executing at the client terminal 144.

There are the following features in the user interface 800:—
An image grid 802: each cell 803 in the grid can be customised to display images from any video capture device 110 connected to the video processing device 100. Clicking on a cell 803 brings up a control panel which can be used to specify which video capture device 110 images come from and a delay. There is also an option to deactivate image downloading for a selected video capture device 110, thereby reducing bandwidth.
A live view 804 shows live images from a particular video capture device 110 selected in the camera list. If a video capture device 110 is a PTZ camera, it can be physically moved by dragging its corresponding live image with the pointing device 114b. If any part of the image is dragged to the centre of the image, the PTZ camera will be moved to centre on that feature. A slider 805 to the one side of the image can be used to control zoom of the PTZ camera. With a preset control 806 below the image, the PTZ camera can be moved to any preset positions. Selecting a movement blocks option highlights any movement between captured sequential images with blue tinged blocks.
An inbox 807 shows recent alarms generated by any of the video capture devices 110 which have been logged on to since starting the client software. Selecting any of the alarms in the inbox will bring up a more detailed description of it, clicking the view button will show a window showing the video surrounding that event and any extra information.
A camera list 808 shows the current status of the video capture devices 110/cameras connected to the video processing device 100.

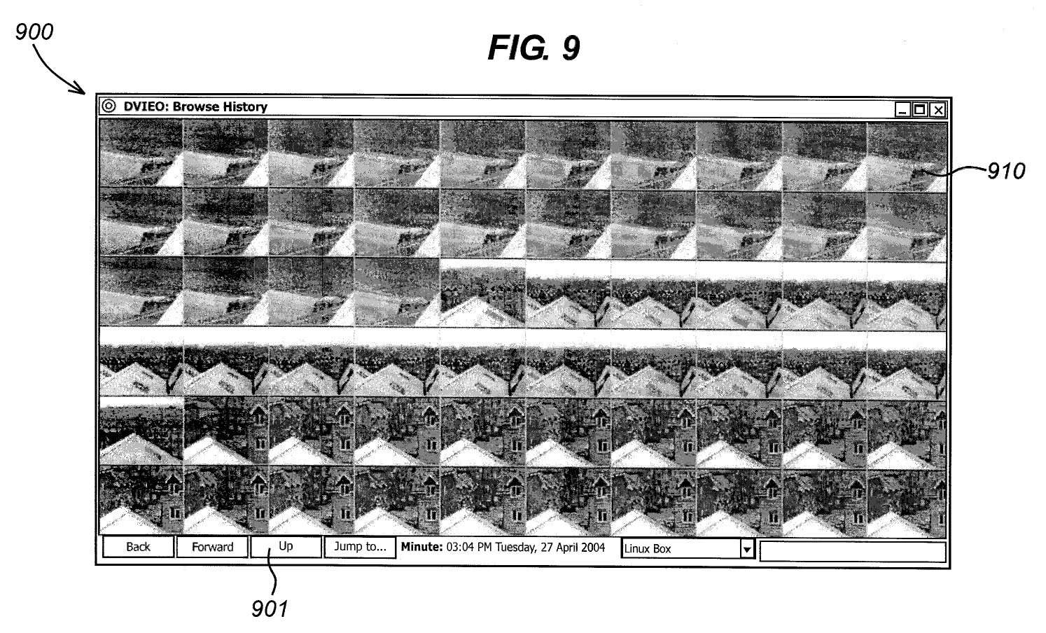

FIG. 9 shows a representation of a history browsing grid 900 displayed by the software executing on the client terminal 114.

The history browsing grid 900 shows thumbnail images from a given time period (which is shown at the bottom of the grid). By default, the grid 900 displays thumbnail images 910 obtained from the video processing device 100 for an interval of one second from the given time period. Clicking on an up button 901 will move the interval up and show thumbnail images for each minute. In this way, a user can navigate through stored images.

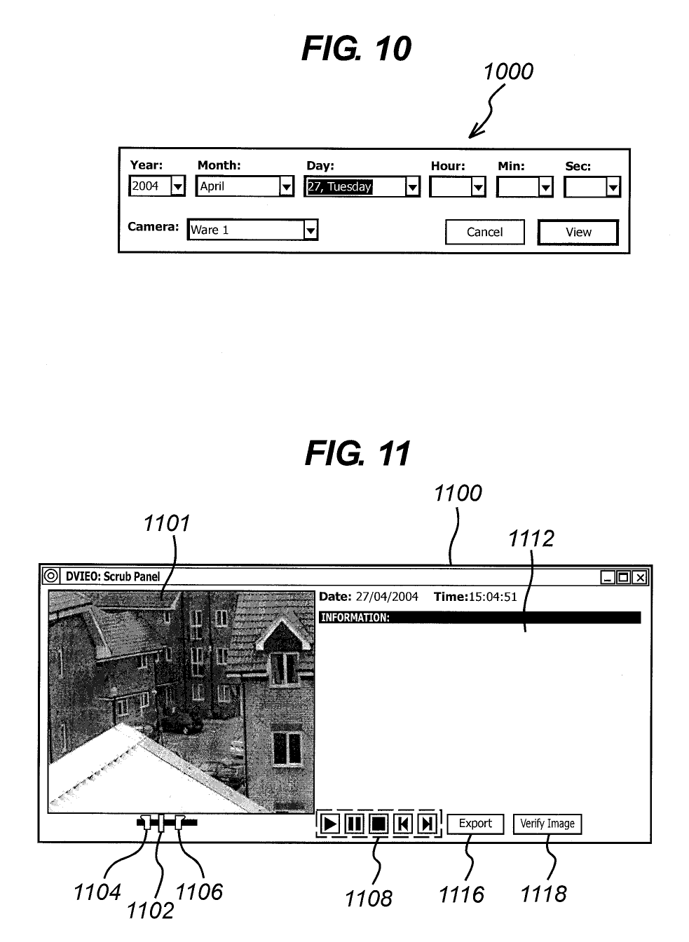

FIG. 10 shows a representation of a time period selection window 1000 displayed by software executing on the client terminal 114. The time period selection window 1000 allows you to select a time period to view captured images from the video processing device 100 in a video area. If you only specify the time period to the nearest day then all the hours in that day will be displayed as thumbnails when you click the view button. If you specify the time period to the nearest minute then all the seconds in that minute will be shown.

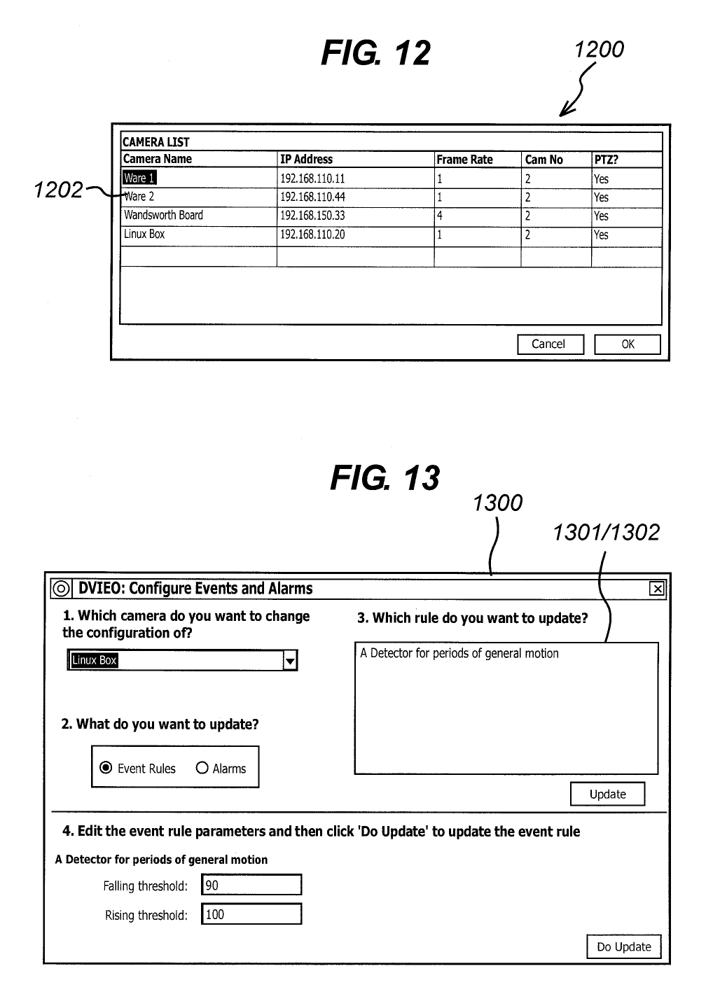

FIG. 11 shows a representation of a scrub panel 1100 displayed by the software executing at the client terminal 114. The scrub panel 1100 shows video surrounding on particular selected image from the stream of images stored at the video processing device 100. Images surrounding a selected time point are loaded in the background at the client terminal 114 and a slider 1102 below the image expands as more video is loaded. The slider 1102 is used to navigate around the video surrounding the time point. Two additional sliders 1104, 1106 mark beginning and end points of a section of video which becomes exported when the export button is clicked. Play, pause and stop buttons 1108 can be used to play through video that has been loaded in the background. Two additional navigation buttons 1110 navigate to the previous or the next frame of video. An information area 1112 shows any extra information associated with the image currently being displayed.

An export button 1116 saves all the images between the two light blue markers into a selected folder. These images can then be stored offline and can be used as evidence as they still have their signatures attached. A verify image button 1118 checks the signature of the currently displayed image to see if the image has been tampered with

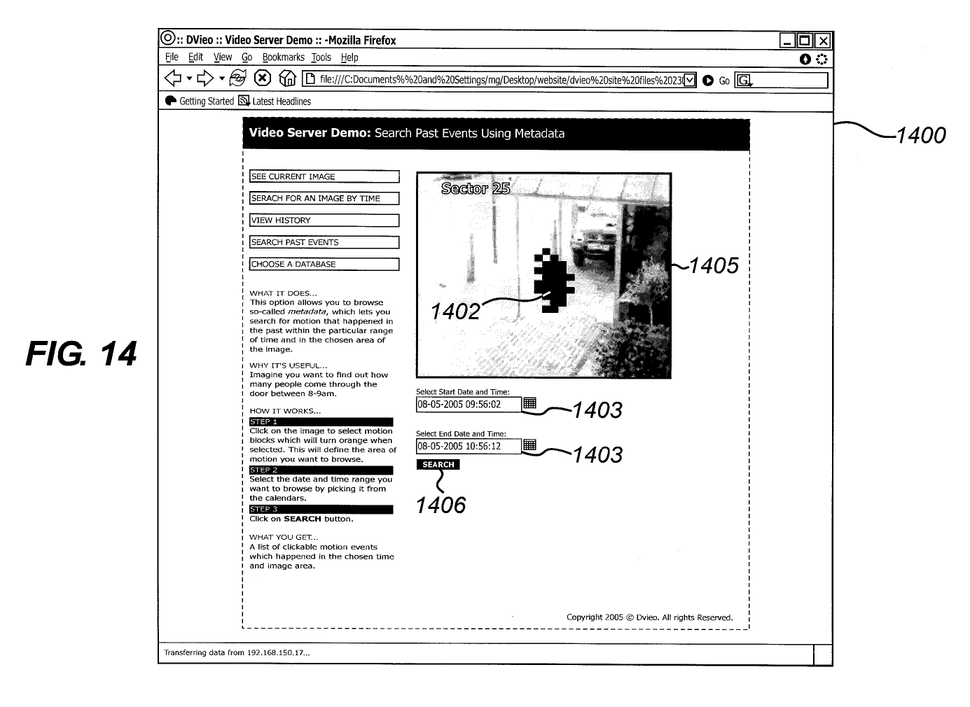

FIG. 12 shows a representation of a configuration window 1200 which is displayed by the software executing on the client terminal 114. The configuration window 1200 allows cameras to be added or deleted from being accessible through the video processing device 100. A camera is added by entering information on a new line of a table 1202. Alternatively, a camera is deleted by deleting all the text in a particular row for a given camera. The IP address of the video processing device 100 can be set, its video capture frame rate can be entered, a camera number can be entered and the camera's PTZ capabilities can also be specified.

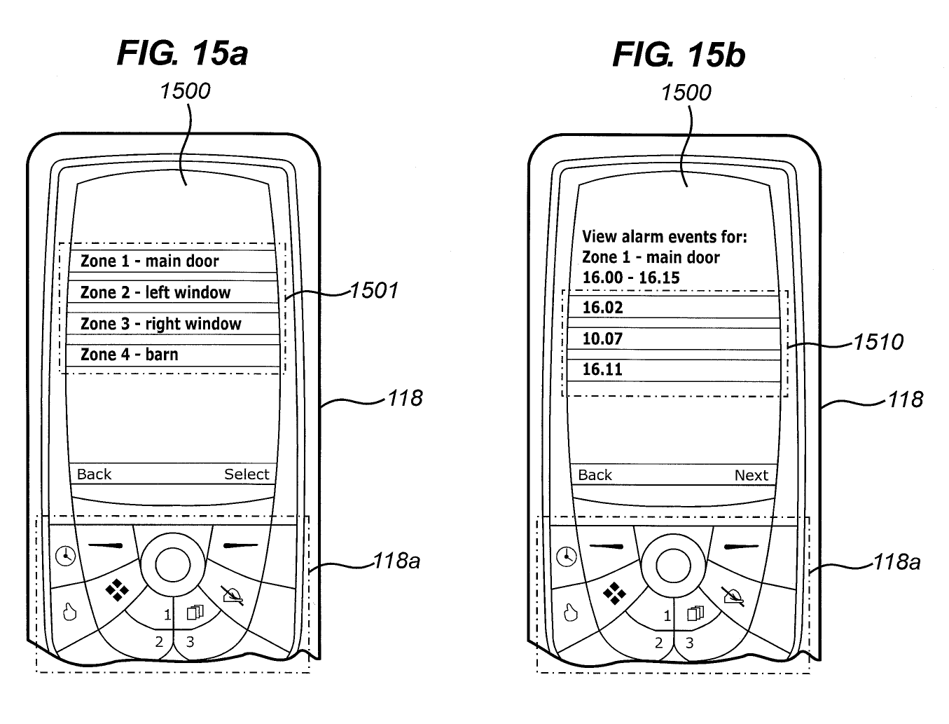

FIG. 13 shows a representation of an events and alarms configuration window 1300 which allows events and alarms options—i.e. search criteria for captured images—to be set for the video processing device 100. The first step is to select which camera you want to edit the settings. The second step is to say whether you want to edit the event rules of the selected camera or the alarms. Event rules determine conditions that are recognised by the system, e.g. a range of a particular colour in a particular sample area or motion within the particular sample area. Alarms determine how recognised events are transmitted to a user. The third step is to select which event rule or alarm to edit. Events and alarms that are accepted by the video processing device 100 are downloaded from the device 100 and are displayed in the events box 1301 or alarms box 1302. As soon as a user has set the events and alarms, these are transmitted and stored in the video processing device 100 and applied to subsequent images captured by the video processing device 100.

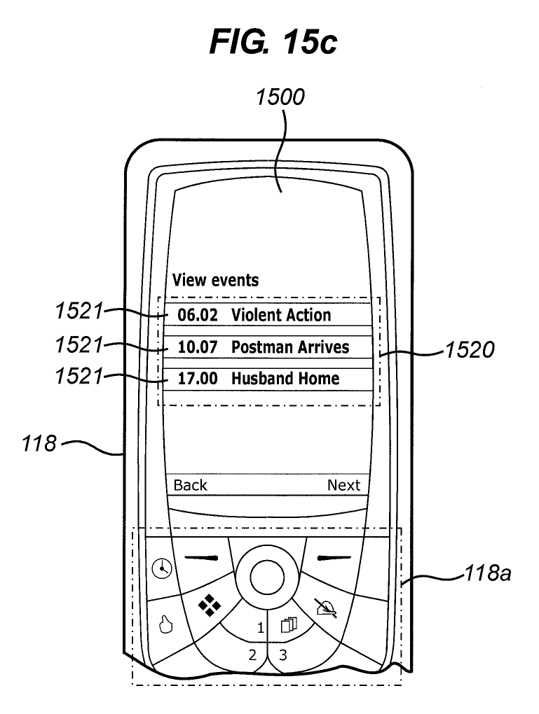

FIG. 14 shows an embodiment of a user interface implemented via a web browser 1400. The client terminal 114 receives web page data (e.g. in Hyper Text Markup Language (HTML)) directly from the video processing device 100. The web page data is interpreted by the client terminal 114 to generate a user interface within a web browser window 1401. As mentioned above, the search query comprises: an image characteristic, a time range and a location reference. In the embodiment shown in FIG. 14, the image characteristic has been selected to be the presence of motion in a sequence of images. The time range is set via date range boxes 1403 and the location reference is set by highlighting a sample area 1402 within a sample video frame 1405 with a pointing device. The pointing device is activated to highlight one or more micro block regions of the sample video frame 1405. Activation of a search button 1406 causes the web browser to send a search query to the video processing device 100 which searches the generated lookup data according to the criteria specified in the search query.

Alternatively, the web page data may have been received via the server 116 to which the generated lookup data and compressed image data is sent after it has been generated, for example, during idle periods in operation of the video processing device 100. The server 116 acts as a dedicated web server allowing multiple connections from a plurality of client devices, thereby reducing the processing burden on the video processing device 100. Generally, the connection to the web server from the Internet will be a high bandwidth dedicated fixed-line connection, whereas the connection between the video processing device 100 and the Internet might only be a broadband (ADSL) connection. Therefore, in an environment in which it is desired to have access to the lookup data and compressed image data from a plurality of client devices, integration of the web server 116 to receive the lookup data and compressed image data in idle periods can increase the access speed to the compressed image and lookup data. The web server can also provide a facility for the client or mobile terminal 114, 118 to download custom client software for executing on the client or mobile terminal 114, 118 to provide enhanced access to the video processing device 100 or server 114.

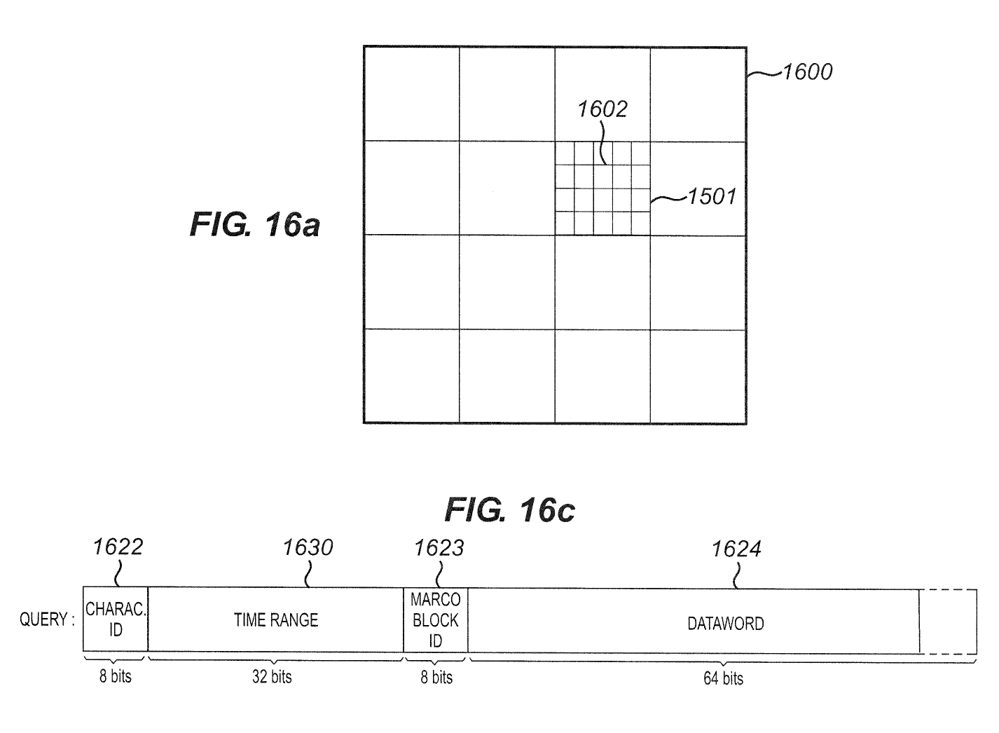

FIGS. 15a and 15b show one embodiment of software executing on a mobile terminal 118. The software allows the user of a mobile terminal 118 to send a search query to the video processing device 100 or server 116 via a user interface 1500 displayed in a display screen of the mobile terminal 118. As mentioned above, one or more identification criteria are preset, stored in the video processing device 100 and transmitted to the mobile terminal 118. The pre-defined identification criteria 1501 (relating to pre-defined location references) are displayed as selectable options in a user interface 1500 as shown in FIG. 15a. A user of the mobile terminal 118 has already specified the time range and image characteristic for the search query (not shown). Activation of one of the selectable options using the keypad 118a completes the generation of the search query by setting the location reference for the search query and transmits the search query to the video processing device 100 (or server 116). The video processing device 100 (or server 116) responds by looking up the search query in its stored lookup data and transmitting search results to the mobile terminal 118 which are displayed as selectable links 1510 in the user interface 1500. Activation of one of the selectable links generates an image request which is transmitted to the video processing device 100 (or server 116) which responds by transmitting the image corresponding to the activated link back to the mobile terminal 118.

FIG. 15c shows an alternative embodiment of software executing on a mobile terminal 118. The mobile terminal 118 has sent a previous search query requesting that all pre-defined combinations of characteristics are searched for in the lookup data. The video processing device 100 (or server 116) has responded by looking up all pre-defined combinations in its stored lookup data and transmitting a list 1520 of hyperlinks 1521 representing each combination that is found to the mobile terminal 118. Each hyperlink 1521 is an event title containing a hidden URL with a flag to its corresponding pre-defined search combination. The descriptive event title can easily understood by a user of the mobile phone, even though it might represent a complex combination of different characteristics that have been identified. Each hyperlink 1521 is displayed as a selectable link in the user interface 1500. Activation of one of the selectable links transmits the URL to the video processing device 100 (or server 116) which looks up the combination of characteristics indicated by the flag in the lookup data to obtain the identification of the video frame which was captured when the combination of characteristics was identified. The video processing device 100 (or server 116) responds by transmitting the video frame corresponding to the identification back to the mobile terminal 118 for display.

FIGS. 16a to 16c show the structure of a location reference in conjunction with a captured image/frame of video and how the location reference is input into a search query and used within the structure of lookup data.

As shown in FIG. 16a, each captured video frame 1600 is segmented into a plurality of macro blocks 1601, each of which is further segmented into a plurality of micro blocks 1602. As an example, an image might be 16×16 macro blocks in size and within each macro block, there might be 8×8 micro blocks. In this scenario, each macro block 1601 has an assigned 6 bit identifier and a micro block 1602 in a given position within each macro block 1601 also has an assigned 8 bit identifier. In this way, a specific micro block within an image is identified by specifying its 8 bit macro block identifier and a 6 bit micro block identifier. The presence of a particular image characteristic in a particular micro block within a macro block is specified by setting a binary ‘1’ value in a 64 bit string (i.e. 8×8 micro blocks). The 64 bit string and an associated macro block identifier can be transmitted as part of the search query for each macro block in which an image characteristic is to be searched for.

FIG. 16b shows the structure of lookup data 1620 generated by the video processing device 100. The structure of the lookup data 1620 is shown in general terms as a data table. However, it will be appreciated that the lookup data may be in the form of metadata, for example in eXtended Markup Language (XML) and the search query may be in Structured Query Language (SQL).

For each macro block 1601 in a captured video frame in which an image characteristic is identified by the video processing device 100, there is a corresponding row within the lookup data 1620, specifying a time value 1621 (including a date) at which the video frame was captured, an image characteristic identifier 1622 (e.g. motion, a particular colour), the macro block identifier 1623 and a 64 bit data word 1624 identifying the micro blocks in which the image characteristic has been identified. The lookup data 1620 is ordered in row order in the following priority order: time, type of characteristic and macro block. The time value 1621 identifies each captured video frame.

For each identified associated characteristic, a time value 1621 and associated characteristic identifier 1622 (e.g. engine noise, smoke) are stored in a row of the lookup data 1620. There is no need for the macro block identifier 1623 and a 64 bit data word 1624 to be utilised when the identified characteristic does not relate to an image characteristic.

In one embodiment of the present invention, the characteristic identifier 1622 is a data-word, with different bits of the data word representing different image and associated characteristics. Thus, the identification of a plurality of characteristics for a particular video frame can be represented in a single row (or a plurality of rows if an image characteristic is detected in more than one macro block) of the lookup table 1620. Each possible combination of characteristics will be represented by a different value of characteristic identifier 1622. Thus, a combination of characteristics can be easily searched for in the lookup data by matching a specific value for the combination with a value in the lookup table.

FIG. 16c shows, in general terms, one embodiment of the structure of a search query including: a characteristic identifier 1622 (corresponding to one of a plurality of predefined image characteristics or associated characteristics), a time range 1630, a macro block identifier 1623 and 64 bit data word 1624 identifying the micro block within the macro block corresponding to the macro block identifier 1623 which is to be searched. On receipt of a search query, the video processing device 100 (or server 116) applies the query to filter the lookup data 1620 to identify micro blocks/frames corresponding to the desired image/associated characteristic within the time specified by the time range 1630. The lookup data 1620 is first restricted to rows with times corresponding to the times within the time range 1630. The lookup data 1620 is then further restricted to rows having the specified characteristic identifier 1622. If the characteristic identifier 1622 is an image characteristic identifier, the lookup data 1620 is then further restricted to rows having the specified macro block identifier 1623. If any of the bit values in the remaining rows of the lookup data 1620 of the specified can be binary ANDed to result in a binary ‘1’ value, an image has been found corresponding to the desired characteristic and the time value 1621 for the image is used to generate a search result which is transmitted to the client or mobile terminal 114, 118.

It will of course be understood that the present invention has been described above purely by way of example and modifications of detail can be made within the scope of the invention.

1. A method of transferring video data, comprising:
(a1) obtaining a stream of video frames from a video capture device;
(b1) identifying at least one characteristic in at least one frame of the stream of video frames;
(c1) generating lookup data which associates the at least one characteristic with each video frame in which the at least one characteristic is identified;
(d1) storing a subset of the stream of video frames and lookup data in memory of the video processing device;
(e1) receiving a search query of a given characteristic from a client;
(f1) determining, from the lookup data, the at least one video frame in the subset of the stream of video frames having the given characteristic; and
(g1) transmitting the at least one video frame corresponding to the given characteristic from the subset of video frames to the client.

2. The method of claim 1, wherein each video frame is an image and the stream of video frames is a sequential stream of images captured by the video processing device.

3. The method of claim 1 or claim 2, wherein the step of storing comprises compressing the stream of video frames by applying a video compression algorithm to the stream of video frames.

4. The method of claim 3, wherein the step of storing a subset of the stream of video frames reduces the frame rate of video data.

5. The method of any one of the preceding claims, further comprising:
(f2) transmitting an identification address for each frame in the stream of video frames having the given characteristic; and
(f3) receiving an identification address from the client for at least frame having the given characteristic,
wherein step (g1) comprises transmitting the at least one video frame corresponding to the received identification address.

6. The method of claim 5, further comprising:
(f2-a) displaying the identification address as a selectable link on a display screen of the client,
wherein the step of receiving comprises receiving the identification address corresponding to a link selected by a user of the client.

7. The method of claim 5 or claim 6, wherein the identification address is a universal resource locator (URL).

8. The method of any one of the preceding claims, wherein the characteristic includes a given colour in one video frame of the stream of video frames.

9. The method of any one of claims 1 to 6, wherein the characteristic includes motion of an element between successive video frames received from the video capture device.

10. The method of any one of the preceding claims, wherein the given characteristic is identified in a given section of each frame in the stream of video frames.

11. The method of any one of the preceding claims, wherein the search query further comprises an indication of a range of times of day for frames identified in the lookup data from which the at least one video frame in the subset of the stream of video frames having the given characteristic is to be determined in step (f1).

12. The method of any one of the preceding claims, further comprising:
(a2) receiving at the video processing device a request for a characteristic to be identified in the stream of video frames during step (b1).

13. The method of any one of the preceding claims, wherein the video processing device is a web server configured to receive a connection from a single client.

14. The method of any one of the preceding claims, wherein the video capture device is a closed-circuit video camera.

15. A video processing device, comprising:
memory adapted to store a stream of video frames received from a video capture device;
a processor connected to the memory and configured to identify at least one characteristic in at least one frame of the plurality of frames, generate lookup data which associates the at least one frame with the characteristic, store a subset of the stream of video frames and lookup data in the memory and determine from the lookup data, the at least one frame in the subset of the stream of video frames having a given characteristic; and
a network interface connected to the processor configured to receive a search query from a client for the given characteristic and transmit the at least one video frame corresponding to the given characteristic from the subset of video frames to the client.

16. The video processing device of claim 15, wherein each video frame is an image and the stream of video frames is a sequential stream of images captured by the video capture device.

17. The video processing device of claim 14 or claim 16, wherein the processor is configured to compress the stream of video frames prior to storing it in the memory.

18. The video processing device of any one of the preceding claims, wherein the processor is further configured to transmit to the client via the network interface an identification address for each frame in the stream of video frames having the given characteristic, receive via the network interface a selected identification address from the client for at least one image having the given characteristic and transmit the at least one frame corresponding to the received identification address to the client.

19. The video processing device of claim 18, wherein the identification address is a universal resource locator (URL).

20. The video processing device of any one of claims 15 to 19, wherein the characteristic includes a given colour in one of the video frames of the stream of video frames.

21. The video processing device of any one of claims 15 to 20, wherein the characteristic includes motion between successive frames received from the image capture device.

22. The video processing device of any one of claims 15 to 21, wherein the processor is further configured to identify the characteristic in a given section of each of the video frames in the plurality of video frames.

23. A web server comprising the video processing device of any one of claims 15 to 21.

24. The web server of claim 23, wherein the network interface is configured to receive a single client connection.

25. A video transfer system comprising:
the video processing device of any one of claims 15 to 21;
a client connected to the video processing device by a network connection; and
a video capture device connected to the video processing device.

26. The video transfer system of claim 25, wherein the video capture device is a closed-circuit video camera.

27. The video transfer system of claim 24 or 26, wherein the client is a mobile telephone.

28. The video transfer system of claim 27, wherein the network connection is implemented via wireless application protocol (WAP).

29. The video transfer system of any one of claims 25 to 28, wherein the video processing device is a web server and the network connection is an internet connection.

30. The video transfer system of claim 29, wherein network interface of the web server is configured to receive only a connection from the client only.

31. A method of image identification, comprising:
(a1) receiving, at a video processing device from a client, a criterion for a given characteristic of an image in a stream of video frames;
(b1) subsequently, obtaining a stream of video frames from an video capture device;
(c1) identifying, at the server, the given characteristic in at least one image of the stream of video frames by:
generating lookup data which associates at least one image from the stream of video frames with the given characteristic;
storing the stream of video frames and lookup data on a server; and
determining, from the lookup data, the at least one image in the stream of video frames having the given characteristic,
(d1) sending a notification to the client that the given characteristic has been detected in at least one image of the stream of video frames.

32. The method of image identification of claim 31, wherein the notification includes the at least one image having the given characteristic.

33. The method of image identification of claim 31, wherein the notification comprises an identification address for the at least one image in the stream of video frames having the given characteristic.

34. The method of image identification of claim 33, further comprising:
(e1) displaying the identification address as selectable link on a display screen of the client.

35. The method of image identification of claim 34, farther comprising:
(f1) receiving, at the video processing device, a selected identification address from the client for an image having the given characteristic; and
(g1) transmitting the image having the given characteristic from the video processing device to the client.

36. The method of any one of claims 33 to 35, wherein the identification address is a universal resource locator (URL).

37. The method of any one of claims 31 to 36, wherein the stream of video frames is a sequential stream of images captured by the video capture device.

38. The method of any one of claims 31 to 37, wherein the step of storing comprises compressing the stream of video frames.

39. The method of any one of claim 38, wherein the step of compressing comprises storing a subset of the stream of video frames.

40. The method of any one of claims 31 to 39, wherein the step of transmitting the at least one image comprises transmitting a selected subset of the compressed stream of video frames to the client.

41. The method of claim 40, wherein the selected subset comprises a single image.

42. The method of any one of claims 31 to 41, wherein the image characteristic includes the presence of a given colour in a given section of at least one image of the stream of video frames.

43. The method of any one of claims 31 to 41, wherein the image characteristic includes the presence of motion of an element of an image between successive video frames received from the video capture device.

44. The method of any one of claims 31 to 43, wherein the given characteristic is identified in a given section of the plurality of images.

45. The method of any one of claims 31 to 44, wherein the client is a mobile device, such as a mobile telephone.

46. The method of any one of claims 31 to 45, wherein the video capture device comprises a web server configured to receive a single client connection.

47. The method of any one of claims 31 to 46, wherein the image capture device is a closed-circuit video camera.

48. A video processing device, comprising:
memory adapted to store a stream of video frames received from a video capture device;
a processor connected to the memory and configured to identify a given characteristic in at least one image of the plurality of frames by generating lookup data which associates at least one image from the stream of video frames with the given characteristic, storing the stream of video frames and lookup data on a server, and determining, from the lookup data, the at least one image in the stream of video frames having the given characteristic; and
a network interface connected to the processor configured to receive a search query from a client for the given characteristic and transmit a notification to the client that the given characteristic has been detected in at least one image of the stream of video frames.

49. The video processing device of claim 48, wherein the notification includes the at least one image having the given characteristic.

50. The video processing device of claim 48, wherein the notification comprises an identification address for the at least one image in the stream of video frames having the given characteristic.

51. The video processing device of claim 50, wherein the processor is further configured to generate the identification address as selectable link on in a page of data for transmission to the client.

52. The video processing device of claim 51, wherein the processor is further configured to receive, via the network interface, a selected identification address from the client for an image having the given characteristic and transmit the image having the given characteristic via the network interface to the client.

53. The video processing device of claims 50 to 52, wherein the identification address is a universal resource locator (URL).

54. The video processing device of claims 48 to 53, wherein the stream of video frames is a sequential stream of images captured by the video capture device.

55. The video processing device of claims 48 to 37, wherein processor is further configured to compress the stream of video frames prior to storing them in the memory.

56. The video processing device of claim 55, wherein the processor is configured to compress the stream of video frames by storing only a subset of the stream of video frames.

57. The video processing device of claims 48 to 56, wherein the network interface is configured to transmit a selected subset of the compressed stream of video frames to the client.

58. The video processing device of claim 57, wherein the selected subset comprises a single image.

59. The video processing device of any one of claims 31 to 41, wherein the image characteristic includes the presence of a given colour in a given section of at least one image of the stream of video frames.

60. The video processing device of any one of claims 31 to 41, wherein the image characteristic includes the presence of motion of an element of an image between successive video frames received from the video capture device.

61. The video processing device of any one of claims 31 to 43, wherein the given characteristic is identified in a given section of the plurality of images.

62. A video transfer system comprising:
the video processing device of any one of claims 48 to 61;
a client connected to the video processing device by a network connection; and
a video capture device connected to the video processing device.

63. The video transfer system of claim 62, wherein the video capture device is a closed-circuit video camera.

64. The video transfer system of claim 62 or 63, wherein the client is a mobile telephone.

65. The video transfer system of claim 64, wherein the network connection is implemented via wireless application protocol (WAP).

66. The video transfer system of any one of claims 62 to 65, wherein the video processing device is a web server and the network connection is an internet connection.

67. The video transfer system of claim 66, wherein the network interface of the web server is configured to receive only a connection from the client.

68. A method of image identification, comprising:
(a1) obtaining a stream of video frames from an video capture device at a first video processing device;
(b1) identifying, at the first video processing device, at least one characteristic in at least one image of the stream of video frames;
(c1) generating, at the first video processing device, lookup data which associates the at least one image with the characteristic;
(d1) storing the stream of video frames and lookup data on the second video processing device;
(e1) receiving, at the second video processing device, a search query for a given characteristic from a client;
(f1) determining, from the lookup data at the second video processing device, the at least one image in the stream of video frames having the given characteristic; and
(g1) transmitting the at least one image to the client from the second video processing device.

69. The method of claim 68, wherein step (c1) comprises storing the lookup data and stream of video frames in memory at the first video processing device and step (d1) comprises transmitting the stored lookup data and stream of video frames from the first video processing device to the second video processing device across a network connection.

70. The method of claim 69, wherein the step of storing in step (c1) comprises compressing the stream of video frames.

71. The method of claim 70, wherein the step of compressing comprises storing only a subset of images from the stream of video frames at the first video processing device and the second video processing device.

72. The method of claim 70 or claim 71, wherein the step of transmitting the at least one image comprises transmitting a section of the compressed video data to the client.

73. The method of any one of claims 68 to 72, further comprising:
(f2) transmitting, from the second video processing device, an identification address for each image in the stream of video frames having the given characteristic; and
(f3) receiving, at the second video processing device, an identification address from the client for at least one image having the given characteristic,
wherein the step of transmitting comprises transmitting the at least one image corresponding to the received identification address.

74. The method of any one of claims 68 to 73, further comprising:
(f2-a) displaying the identification address as selectable link on a display screen of the client,
wherein step (e1) comprises receiving the identification address corresponding to a link selected by a user of the client.

75. The method of any one of claims 68 to 73, wherein the second video processing device is configured to receive a plurality of search queries from a plurality of clients and steps (e1) to (g1) are performed at the second video processing device independently for each received search query.

76. The method of any one of claims 68 to 75, wherein the characteristic includes the presence of a given colour in a given section of an image in the stream of video frames;

77. The method of any one of claims 68 to 76, wherein the characteristic includes presence of motion of an element of in an image between successive frames received from the video capture device;

78. The method of any one of claims 68 to 77, wherein the characteristic is identified in a given section of the plurality of images.

79. The method of any one of claims 68 to 78, further comprising:
(a2) receiving, at the first video processing device, a request for the given characteristic to be identified in the plurality of images.

80. The method of any one of claims 68 to 79, wherein the client is a mobile device, such as a mobile telephone.

81. The method of any one of claims 68 to 80, wherein the first video processing device is included in a first server configured to receive data from and transmit data to a single client connection and the second video processing device is included in a second server configured to receive data from and transmit data to multiple clients.

82. The method of any one of claims 68 to 81, wherein the video capture device is a closed-circuit video camera.

83. A video transfer system comprising:
a first video processing device configured to obtain a stream of video frames from a video capture device, identify at least one characteristic in at least one image of the stream of video frames and generating lookup data which associates the at least one image with the characteristic; and
a second video processing device connected to the first video processing device across a network connection and configured to store the stream of video frames and lookup data in second memory, receive a search query from a client for a given characteristic in the stream of video frames and determine, from the lookup data, the at least one image in the stream of video frames having the given characteristic and transmit the at least one image to the client.

84. The video transfer system of claim 83, wherein the first processing device is configured to store in first memory the lookup data and stream of video frames and transmit the lookup data and stream of video frames to the second video processing device across the network connection.

85. The video transfer system of claim 84, wherein the first processing device is further configured to compress the stream of video frames prior to storing in the first memory.

86. The video transfer system of claim 85, wherein the first processing device compresses the stream of video frames by storing only a subset of images from the stream of video frames in the first memory.

87. The video transfer system of any one of claims 83 to 86, wherein the second video processing device is configured to receive a plurality of search queries from a plurality of clients.

88. The video transfer system of any one of claims 83 to 87, wherein the client is a mobile device, such as a mobile telephone.

89. The video transfer system of any one of claims 83 to 88 wherein the first video processing device comprises a first server configured to receive data from and transmit data to a single client and the second video processing device is configured to receive data from and transmit data to multiple clients.

90. The video transfer system of any one of claims 83 to 89, wherein the video capture device is a closed-circuit video camera.

91. A method of transferring video data, comprising:
(a1) obtaining a stream of video frames from a video capture device;
(b1) identifying at least one characteristic corresponding to at least one frame of the stream of video frames;
(c1) generating lookup data which associates the at least one characteristic with each video frame in which the at least one characteristic is identified;
(d1) storing a subset of the stream of video frames and lookup data in memory of the video processing device;
(e1) receiving a search query of a given characteristic from a client; and
(f1) determining, from the lookup data, the at least one video frame in the subset of the stream of video frames corresponding to the given characteristic.

92. The method of claim 91, wherein the step of identifying includes identifying the presence of given colour in one video frame of the stream of video frames.

93. The method of any one of claims 91 or 92, wherein the step of identifying includes detecting motion of an element between successive video frames received from the video capture device.

94. The method of any one of claims 92 or 93, wherein the step of identifying comprises identifying the given characteristic in a given segment of one or more of the video frames.

95. The method of any one of claims 91 to 94, wherein the step of identifying includes detecting the presence of a given sound with a sound detector connected to the video processing device.

96. The method of any one of claims 91 to 95, wherein the step of identifying includes detecting the presence of a given odor with an odor detector connected to the video processing device.

97. The method of any one of claims 91 to 96, wherein the search query further comprises an indication of a range of times of day for frames identified in the lookup data from which the at least one video frame in the subset of the stream of video frames corresponding to the given characteristic is to be determined in step (f1).

98. The method of any one of claims 91 to 97, wherein the search query further comprises a combination of specified characteristics and the step of determining comprises determining, from the lookup data, at least one video frame in the subset of the stream of video frames having the combination of specified characteristics in the lookup data.

99. The method of claim 98, wherein the combination of specified characteristics defines a specific event.

100. The method of claim 98 or claim 99, wherein the combination of specified characteristics is a boolean combination of given characteristics.

101. The method of any one of claims 98 to 100, wherein the video processing device is configured to store one or more pre-defined combinations of specified characteristics in memory of the video processing device.

102. The method of claim 101, wherein the search query comprises a flag to one of the pre-defined combinations of specified characteristics stored in memory of the video processing device and the step of determining comprises obtaining the pre-defined combination of specified characteristics corresponding to the flag from the memory and identifying at least one video frame in the subset of the stream of video frames corresponding to the obtained pre-defined combination.

103. The method of any one of claims 91 to 102, further comprising:
(a2) receiving at the video processing device a request for a characteristic to be identified during step (b1); and
(a3) configuring the video processing device to identify the characteristic corresponding to the request during step (b1).

104. A video processing device, comprising:
memory adapted to store a stream of video frames received from a video capture device;
a processor connected to the memory and configured to identify at least one characteristic corresponding to at least one frame of the plurality of frames, generate lookup data which associates the at least one frame with the characteristic, store a subset of the stream of video frames and lookup data in the memory and determine from the lookup data, at least one frame in the subset of the stream of video frames having corresponding to the given characteristic; and
a network interface connected to the processor configured to receive a search query from a client for the given characteristic.

105. The video processing device of claim 104, wherein the processor is configured to identify the presence of given colour in one video frame of the stream of video frames.

106. The video processing device of claim 104 or claim 105, wherein the processor is configured to detect motion of an element between successive video frames received from the video capture device.

107. The video processing device of any one of claims 104 to 106, wherein the processor is configured to identify the given characteristic in a given segment of one or more of the video frames.

108. The video processing device of any one of claims 104 to 107, further comprising a sound detector connected to the processor,
wherein the processor is configured to detect the presence of a given sound as one of the characteristics.

109. The video processing device of any one of claims 104 to 108, further comprising an odor detector connected to the processor,
wherein the processor is configured to detect the presence of a given odor as one of the characteristics.

110. The video processing device of any one of claims 104 to 109, wherein the search query further comprises an indication of a range of times of day for frames identified in the lookup data from which the at least one video frame in the subset of the stream of video frames corresponding to the given characteristic being determined.

111. The video processing device of any one of claims 104 to 110, wherein the search query further comprises a combination of specified characteristics and the processor is configured to determine, from the lookup data, at least one video frame in the subset of the stream of video frames having the combination of specified characteristics in the lookup data.

112. The video processing device of claim 111, wherein the combination of specified characteristics defines a specific event.

113. The video processing device of claim 111 or claim 112, wherein the combination of specified characteristics is a boolean combination of given characteristics.

114. The video processing device of any one of claims 111 to 113, wherein the memory is adapted to store one or more pre-defined combinations of specified characteristics.

115. The video processing device of claim 114, wherein the search query comprises a flag to one of the pre-defined combinations of specified characteristics stored in memory of the video processing device and the processor is configured to obtain the pre-defined combination of specified characteristics corresponding to the flag from the memory and identify at least one video frame in the subset of the stream of video frames corresponding to the obtained pre-defined combination.

116. The video processing device of any of claims 104 to 115, wherein the network interface is further configured to receive a request for a characteristic to be identified by the processor; and the processor is further adapted to configure itself to identify the characteristic corresponding to the request.

117. A method of transferring video data, substantially as hereinbefore described with reference to the accompanying drawings.

118. A method of image identification, substantially as hereinbefore described with reference to the accompanying drawings.

119. A video processing device, substantially as hereinbefore described with reference to the accompanying drawings.

120. A video transfer system, substantially as hereinbefore described with reference to the accompanying drawings.
